(19) United States
(12) Patent Application Publication
(10) Pub. No.: US 2007/0119096 A1
(43) Pub. Date: May 31, 2007

(54) Method of agricultural operations management producing an odor control mixture and an active soil amendment

(76) Inventor: John M. Halliday, San Francisco, CA (US)

Correspondence Address: HOLLAND LAW OFFICE P.L.L.C., P.O. BOX 1840, BOISE, ID, 83701-1840, US

(21) Appl. No.: 11/290,656

(22) Filed: Nov. 29, 2005

(51) Int. Cl. C09K 17/14

(52) U.S. Cl. 47/58.1 SC

(57) ABSTRACT

A method of agricultural operations management including formulating an odor control mixture including zeolite mixed with an ammonium containing manure at a ratio of zeolite to manure in the range of 1:1 to 1:33 by volume. Moisture content of the odor control mixture is preferably maintained in the range of 15-25%. An active organic soil amendment may be produced by amending the odor control mixture, or preparing a fresh mixture, including zeolite mixed with manure at a ratio of zeolite to manure in the range of 1:1 to 1:4 by volume. A horticultural medium may be produced by mixing the active organic soil amendment mixed with the soil at a ratio in the range of 1:9-1:99, active organic soil amendment to soil by volume, for use in conventional, organic and certified organic horticulture.

### BACKGROUND OF THE INVENTION

1. Field of the Invention

This invention relates generally to methods of agricultural operations management and more particularly to the preparation of an odor control mixture and a soil amendment mixture and to the preparation of a horticultural medium used in conventional and certified organic horticulture.

2. Prior Art

A variety of horticultural media are available including various combinations of soil, compost, fertilizers and zeolite and/or other constituents and soil amendments prepared in a variety of methods. U.S. Pat. No. 4,337,078 to Petrov, et al. entitled Substrate for Cultivation of Agricultural Crops and Rooting of Green Cuttings in Greenhouses and In Open Air discloses a substrate for the cultivation of agricultural crops consisting essentially of clinoptylolite natural zeolite, sterilized at 250° to 350° C., in particle size fractions of 0.8 to 2.0 mm, 2.0 to 5.0 mm and 5.0 to 8.0 mm respectively in proportions from 1:1:0.01 to 2:3: enriched with nitrogen and phosphorus in an amount of 0.1 to 0.5% by nitrogenous and phosphorous fertilizers, fractionated raw vermiculite in a particle size of up to 1.0 mm and expanded vermiculite with a particle size of 5.0 to 15.0 mm in a proportion of 1:9 to 2:8 and organic mass peat, the proportion of the zeolite:vermiculite:peat being from 10:0.01:0.01 to 5:2:3.

U.S. Pat. No. 5,106,405 to Goto entitled Horticultural Medium Consisting Essentially of Natural Zeolite Particles discloses a mixed horticultural medium consisting essentially of natural zeolite particles, containing nitrifying bacteria, a nitrogen content of 0.05 to 0.2 parts of nitrogen N, to 100 parts of zeolite particles. According to Goto, the horticultural medium includes an ammonium-nitrogen content of 0.02 to 0.2 g/100 g, a nitrate-nitrogen content of 0.005 to 0.05 g/100 g a pH of 6.0 to 7.5, an electric conductivity less than 2.0 mS/cm, and a cation exchange capacity is more than 50 meq/100 g, preferably 80 meq/100 g. According to Goto, the horticultural medium includes 100 parts of zeolite particles to 10 to 40 parts of compost and approximately 2-26 parts of other constituents including sludge, converter slag, nitrogen and phosphate fertilizers.

U.S. Pat. No. 5,451,242 to Ming et al., entitled Active Synthetic Soil discloses a synthetic medium for horticultural application having all the agronutrients essential for plant growth. The soil comprises a synthetic apatite fertilizer having sulfur, magnesium and micronutrients dispersed in a calcium phosphate matrix, a zeolite cation exchange medium saturated with a charge of potassium and nitrogen cations, and an optional pH buffer. Moisture dissolves the apatite and mobilizes the nutrient elements from the apatite matrix and the zeolite charge sites. Ming et al., teach preparing a crystalline calcium phosphate precipitate and mixing zeolite charged with ammonium and potassium cations at a proportion of from about 5 to about 100 parts by weight of the precipitate per 100 parts by weight of the ammonium and potassium charged zeolites.

Advantage may be found providing a method of agricultural operations management that provides for reduction of odors associated with the production of manure, the production of an active organic soil amendment employing the byproduct of odor reduction and the formulation of a horticultural medium including the active organic soil amendment. Advantage may also be found in formulating an active organic soil amendment that includes relatively low levels of zeolite mixed with an ammonium containing fertilizer. Advantage may be found as well in formulating a horticultural medium including between 1 and 10% zeolite or an active organic soil amendment including between 1 and 10% zeolite.

One objective of the present invention, therefore, is to provide a method of agricultural operations management that provides for reduction of odors associated with the production of manure, the production of an active organic soil amendment employing the byproduct of odor reduction and the formulation of a horticultural medium including the active organic soil amendment. One objective of the present invention, therefore, is to provide an active organic soil amendment and a method for preparing an active organic soil amendment including between 1 and 10% zeolite. Another objective of the present invention is to provide a horticultural medium and a method for preparing a horticultural medium including a soil and a mixture of zeolite or an active organic soil amendment resulting in a horticultural medium having a concentration of zeolite in the range of 1 and 10%.

### SUMMARY OF THE INVENTION

The present invention is directed broadly to a method of agricultural operations management including the step of formulating an odor control mixture including zeolite mixed with an ammonium containing manure produced in various livestock and poultry operations. The method of agricultural operations management may also include the step of producing an active organic soil amendment including the odor control mixture amended to include zeolite mixed with manure at a specified ratio. The method of agricultural operations management may also include the step of mixing the active organic soil amendment with a soil to provide a horticultural medium including a ratio of the active organic soil amendment to soil in the range of 1:99 to 10:90, (1-10%), by volume active organic soil amendment to soil for use in conventional and certified organic horticulture.

An odor control mixture according to the present invention, includes zeolite mixed with an ammonium containing manure at a ratio of zeolite to manure in the range of 1:1 to 1:33 by volume, while controlling the moisture content of the mixture in the range of 15-25%. In a preferred embodiment, the odor control mixture of the present invention includes a clinoptilolite zeolite that has been processed such that it is sized in the range of 0.1 mm-0.5 mm mixed with an ammonium containing manure in a concentration in the specified concentration.

An active organic soil amendment according to the present invention includes a mixture of zeolite and an ammonium containing fertilizer, preferably a manure selected from the group of manures including bat guano, cow manure, steer manure, horse manure, poultry manure, swine manure, goat manure, sheep manure and rabbit manure. In the event that the active organic soil amendment according to the present invention is produced for use in accordance with standards set forth by the National Organic Standards and the National Materials Research Institute, the manure used to formulate such active organic soil amendment according to the present invention must of course meet the standards of said bodies.

In a preferred embodiment, the active organic soil amendment includes zeolite mixed with an ammonium containing manure at a ratio of zeolite to manure in the range of 1:1 to 1:4 by volume. In a preferred embodiment, in the management of agricultural operations, the odor control mixture produced according to the method of the invention including a mixture of zeolite to manure, may be amended as needed to provide an active organic soil amendment including zeolite mixed with an ammonium containing manure at a ratio of zeolite to manure in the range of 1:1 to 1:4 by volume.

The present invention is also directed to a horticultural medium including an active organic soil amendment mixed with a soil, the active organic soil amendment including a mixture of zeolite and an ammonium containing fertilizer. In a preferred embodiment, the active organic soil amendment is mixed with soil at a ratio of active organic soil amendment to soil in the range of 1:9 to 1:99 by volume.

The present invention consists of the parts hereinafter more fully described and more particularly pointed out in the appended claims, it being understood that changes may be made in the form, size, proportions and minor details of the invention without departing from the spirit or sacrificing any of the advantages of the invention.

### DETAILED DESCRIPTION OF THE INVENTION

Method of Agricultural Operations Management.

A method of agricultural operations management includes the steps of formulating an odor control mixture including zeolite mixed with an ammonium containing manure at a ratio of zeolite to ammonium containing manure in the range of 1:1 to 1:33 by volume. Manure, selected from the group of manures including bat guano, cow manure, steer manure, horse manure, poultry manure, swine manure and rabbit manure is mixed with clinoptilolite zeolite that has been processes such that it is sized in the range of 0.1 mm-0.5 mm and the moisture content of the mixture is controlled in the range of 15-25%.

In one instance, an odor control mixture was formulated by mixing zeolite with chicken manure at a ratio of 1:3 by volume. The zeolite was a natural clinoptilolite zeolite that had been processed such that it was sized in the range of 0.1 mm-0.4 mm and the moisture content of the mixture is controlled at 15%. In other studies, an odor control mixture was formulated including chicken manure mixed with clinoptilolite zeolite that had been processed such that it was sized in the range of 0.4 mm-0.5 mm and the moisture content of the mixture is controlled in the range of 15-25%. In both of the above treatments odor, as determined qualitatively, was reduced substantially.

Active Organic Soil Amendment.

An active organic soil amendment according to the present invention includes a mixture including a zeolite particulate and an ammonium containing fertilizer. In the preferred embodiment, a zeolite of the clinoptilolite variety is mixed with an ammonium containing fertilizer. The preferred zeolite of the clinoptilolite variety may include:

a SiO₂ level in the range of 62-72%,

a Al₂O₃ level in the range of 11-13%,

a CaO level in the range of 0.5-3.5%,

a MgO level in the range of 0.0-1.5%,

a NaO₂ level in the range of 0.5-3.75%,

a K₂O level in the range of 2.5-4.0%,

a Fe₂O₃ level in the range of 0.5-2.0%

a MnO level in the range of 0.0-0.75%, and

a SiO₂/Al₂O₃ ratio in the range of 5.0-6.0.

The preferred zeolite also exhibits:

a cation exchange capacity, (CEC) greater than 80, or in the alternative in the range of 80-225 cmol kg⁻¹,

exchangeable calcium in the range of 75.0-80.0 meq/100 g or substantially equal to 76.5 meq/100 g,

an exchangeable potassium in the range of 20-25 meq/100 g or substantially equal to 24 meq/100 g

an exchangeable sodium in the range of 4.0-4.5 meq/100 g or substantially equal to 4.4 meq/100 g

an electrical conductivity in the range of 0.9-1.2 dS/m or substantially equal to 1.1 dS/m, and

a pH in the range of 7.7-8.5 or substantially equal to 8.1.

In the preferred embodiment, a zeolite particulate is prepared having a size of less than 0.5 mm. More specifically, in the preferred embodiment, a natural clinoptilolite zeolite processed such that it is sized in the range of 0.1 mm-0.5 mm. It is believed, without being bound by such theory, that the natural clinoptilolite zeolite, when processed such that it is sized in the range of 0.1 mm-0.5 mm, provides an optimum size or configuration to permit uptake of positively charged ions.

According to the present invention, the ammonium-containing fertilizer may include a manure selected from the group of manures including bat guano, cow manure, steer manure, horse manure, poultry manure, swine manure and rabbit manure, with chicken manure or bat guano being preferred. In the preferred embodiment of the active organic soil amendment, zeolite is mixed with an organic fertilizer in the form of manure with at a ratio in the range of 1:1 to 1:4 zeolite to manure by volume.

The active organic soil amendment according to the present invention exhibits total nitrogen in the range of 1-8% by oven dry weight basis. Of this 1-8% total nitrogen, 75-85% constitutes organic nitrogen, and 15-25% constitutes inorganic nitrogen. Of the 15-25% inorganic nitrogen, 80-85% constitutes exchangeable NH₄—N, 5-10% constitutes water soluble NH₄—N and 5-15% constitutes NO₃—N. In the alternative, the active organic soil amendment may exhibit as a percentage of total dried weight, exchangeable NH₄—N in the range of 0.30-0.70%, water soluble NH₄—N in the range of 0.01-0.20% and NO₃—N in the range of 0.01-0.30%. Alternately, the active organic soil amendment according to the present invention may exhibit exchangeable NH₄—N in the range of 10-3525 meq/100 g, (1300-5000 mg/kg), water soluble NH₄—N in the range of 1.0-85 meq/100 g, (200-12,000 mg/kg) and NO₃—N in the range of 0.50-12.0 meq/100 g, (90-1700 mg/kg).

### EXAMPLE 1

### Active Organic Soil Amendment

A mixture was made combining 25 parts zeolite to 100 parts guano by volume. The zeolite used was a natural clinoptilolite zeolite particulate screened so that the material used is in the range of 0.1 mm-0.5 mm. The guano used exhibited a total nitrogen content of 10%. Testing of the active organic soil amendment showed that 78% was present in organic form and 22% of the total nitrogen was present in inorganic form. Of the 22% nitrogen present in inorganic form, 44.90% was in the form of an exchangeable NH₄—N, 46.95% was in the form of water soluble NH₄—N and 8.25% was in the form of NO₃—N. Analysis of the mixture indicated that the active organic soil amendment exhibited exchangeable NH₄—N of 35 meq/100 g, water soluble NH₄—N of 37 meq/100 g and NO₃—N of 6.3 meq/100 g.

Horticultural Medium.

A horticultural medium according to one aspect of the present invention is prepared by mixing an active organic soil amendment according to the present invention at a rate of 1-10% with soil prior to planting. In the preferred embodiment, the active organic soil amendment is mixed with soil at a ratio in the range of 1:9-1:99, active organic soil amendment to soil by volume. Alternately, a horticultural medium according to one aspect of the present invention is prepared by mixing zeolite, ammonium-containing fertilizer and a soil at a ratio in the range of 0.25:0.5:99.25 to 1:1:18.

While this invention has been described with reference to the detailed embodiments, this description is not meant to be construed in a limiting sense. Various modifications to the described embodiments, as well as additional embodiments of the invention, will be apparent to persons skilled in the art upon reference to this description. It is therefore contemplated that the appended claims will cover any such modifications or embodiments as fall within the true scope of the invention.

What is claimed is:

1. A method of agricultural operations management including the steps of:
preparing an odor control mixture including zeolite mixed with an ammonium containing manure at a ratio of zeolite to manure in the range of 1:1 to 1:33 byvolume; and
controlling a moisture content of the odor control mixture in the range of 15-25%.

2. The method of agricultural operations management also including the step of producing an active organic soil amendment including the odor control mixture, the odor control mixture amended to include zeolite mixed with manure a ratio of zeolite to manure in the range of 1:1 to 1:4 by volume.

3. The method of agricultural operations management also including the step of mixing the active organic soil amendment with a soil to provide a horticultural medium including the active organic soil amendment mixed with the soil at a ratio in the range of 1:9-1:99, active organic soil amendment to soil by volume, for use in conventional, organic and certified organic horticulture.

4. An active organic soil amendment comprising zeolite mixed with an ammonium containing fertilizer at a ratio of zeolite to ammonium containing fertilizer in the range of 1:1 to 1:4 by volume.

5. The active organic soil amendment according to claim 4 wherein the zeolite further comprises a particulate having a diameter of less than 0.5 mm.

6. The active organic soil amendment according to claim 4 wherein the zeolite further comprises a particulate having a diameter in the range of 0.1 mm-0.5 mm.

7. The active organic soil amendment according to claim 4 wherein the ammonium-containing fertilizer further comprises a manure.

8. The active organic soil amendment according to claim 4 wherein the ammonium-containing fertilizer further comprises a manure, selected from the group of manures including bat guano, cow manure, steer manure, horse manure, poultry manure, swine manure and rabbit manure.

9. A horticultural medium comprising an active organic soil amendment mixed with a soil at a ratio in the range of 1:9-1:99, active organic soil amendment to soil by volume.

10. The horticultural medium of claim 9 wherein the active organic soil amendment further comprises a natural clinoptilolite zeolite particulate mixed with an ammonium-containing fertilizer at a ratio of natural clinoptilolite zeolite particulate to ammonium containing fertilizer in the range of 1:1 to 1:4 by volume.

11. The horticultural medium of claim 10 wherein the natural clinoptilolite zeolite particulate further comprises a particulate having a diameter of less than 0.5 mm.

12. The horticultural medium of claim 10 wherein the natural clinoptilolite zeolite particulate further comprises a particulate sized in the range of 0.1 mm-0.5 mm.

13. The horticultural medium of claim 10 wherein the ammonium-containing fertilizer further comprises manure.

14. The horticultural medium of claim 10 wherein the ammonium-containing fertilizer further comprises a manure, selected from the group of manures including bat guano, cow manure, steer manure, horse manure, poultry manure, swine manure and rabbit manure.
